(19) United States
(12) Patent Application Publication
(10) Pub. No.: US 2025/0358555 A1
(43) Pub. Date: Nov. 20, 2025

(54) LOUDSPEAKER COVER PLATE, SOUND PLAYING APPARATUS AND TERMINAL

(71) Applicants: ZHEJIANG ZEEKR INTELLIGENT TECHNOLOGY CO., LTD., Ningbo (CN); ZHEJIANG GEELY HOLDING GROUP CO., LTD., Hangzhou (CN)

(72) Inventors: Mingzhen ZHAO, Ningbo (CN); Yan LI, Ningbo (CN); Liguang ZHANG, Ningbo (CN); Guolin LI, Ningbo (CN); Jianhua LIU, Ningbo (CN)

(21) Appl. No.: 18/874,076

(22) PCT Filed: May 23, 2023
(86) PCT No.: PCT/CN2023/095908

§ 371 Date: Dec. 11, 2024

(30) Foreign Application Priority Data
Jun. 13, 2022 (CN) 202210673550.4

(51) Int. Cl. H04R 1/02

(52) U.S. Cl. CPC H04R 1/023; H04R 2499/13

(57) ABSTRACT

The present disclosure provides a loudspeaker cover plate, a sound playing apparatus and a terminal. The loudspeaker cover plate includes a substrate and an appearance piece covering the substrate. The substrate is configured to connect to a loudspeaker. The appearance piece is located on a surface of the substrate away from the loudspeaker. A plurality of first through holes are arranged on the substrate, a plurality of second through holes are arranged on the appearance piece, and at least some of the second through holes are opposite to the first through holes. A forming material of the appearance piece is a leather material. The material of the leather appearance piece is soft, so that the hardness of the loudspeaker cover plate may be effectively reduced, and good touch experience may be brought to a user during touch, thereby effectively improving the touch feeling of the loudspeaker cover plate.

### CROSS-REFERENCE TO RELATED APPLICATIONS

The present application is a National Stage of International Application No. PCT/CN2023/095908, filed on May 23, 2023, which claims priority to Chinese Patent Application No. 202210673550.4 filed with China National Intellectual Property Administration on Jun. 13, 2022 and entitled “LOUDSPEAKER COVER PLATE, SOUND PLAYING APPARATUS AND TERMINAL”. The two applications are hereby incorporated by reference in their entireties.

### TECHNICAL FIELD

The present disclosure relates to the technical field of loudspeakers, in particular to a loudspeaker cover plate, a sound playing apparatus and a terminal.

### BACKGROUND

Sound box refers to a sound playing apparatus that may convert audio signals into sound. It may amplify the audio signals and then play back the sound from the sound box itself to make the sound louder. Sound box is the terminal of the whole sound system, and its function is to convert audio electric energy into corresponding sound energy and radiate which into space. Sound box is an extremely important part of sound system, which is responsible for converting electrical signals into acoustic signals for people's ears to listen to directly. Sound box has a very wide range of applications, such as radios, players, notebooks, vehicles and other devices with sound generation functions.

Taking the application of sound boxes in vehicles as an example, typically, sound boxes include a loudspeaker and a loudspeaker cover plate covered on top of the loudspeaker, where the loudspeaker is configured to propagate sound further and larger, while the loudspeaker cover plate is configured to shield the loudspeaker to decorate the sound box and improve the attractiveness. At present, the loudspeaker cover plate is usually a plastic piece. By opening a mesh on the loudspeaker cover plate of the plastic piece, the sound may be transmitted through the mesh.

However, the touch and texture of the loudspeaker cover plate are poor, which reduces the attractiveness of the speaker and affects the user experience.

### SUMMARY

The present disclosure provides a loudspeaker cover plate, a sound playing apparatus and a terminal, so as to solve the problems that the existing loudspeaker cover plate has poor touch and texture, reduces the attractiveness of a sound box and affects the user experience.

The first aspect of the present disclosure provides a loudspeaker cover plate, which is configured to connect to a loudspeaker, and includes a substrate and an appearance piece covering the substrate, the substrate is configured to connect to the loudspeaker, and the appearance piece is located on a surface of the substrate away from the loudspeaker;
a plurality of first through holes are arranged on the substrate, a plurality of second through holes are arranged on the appearance piece, and at least some of the second through holes are opposite to the first through holes; and
a forming material of the appearance piece is a leather material.

A forming material of the appearance piece is a leather material. The material of the leather appearance piece is soft, so that the hardness of the loudspeaker cover plate may be effectively reduced, and good touch experience may be brought to a user during touch, thereby effectively improving the touch feeling of the loudspeaker cover plate. Moreover, lines on the surface of the leather appearance piece are relatively natural and good in glossiness, so that the texture of the loudspeaker cover plate may be effectively improved, the overall attractiveness of the loudspeaker cover plate is improved, the interior of a vehicle looks more attractive and elegant, which is beneficial to improve the overall attractiveness and the feeling of high class of the interior of the vehicle as well as the user experience.

In a possible implementation, the loudspeaker cover plate further includes a flexible layer, the flexible layer is located between the appearance piece and the substrate.

In a possible implementation, the loudspeaker cover plate further includes a base fabric layer, the base fabric layer is connected to the appearance piece, and the base fabric is located on a surface of the appearance piece facing the substrate.

In a possible implementation, the forming material of the appearance piece at least includes natural leather, artificial leather, recycled leather or synthetic leather.

In a possible implementation, a size of the first through holes is larger than a size of the second through holes.

In a possible implementation, a shape of the second through holes at least comprises a square, a circle and a triangle.

In a possible implementation, the size of the second through holes is 2.5 mm to 5 mm, and a distance between the two adjacent second through holes is 1.25 mm to 10 mm.

In a possible implementation, the flexible layer is a three dimensional (3D) mesh fabric.

The second aspect of the present disclosure provides a sound playing apparatus, at least includes a loudspeaker and any one of the foregoing loudspeaker cover plate, where the loudspeaker cover plate covers the loudspeaker.

The third aspect of the present disclosure provides a terminal, at least includes the foregoing sound playing apparatus.

### BRIEF DESCRIPTION OF DRAWINGS

To describe the technical solutions in embodiments of the present disclosure or in the prior art more clearly, the following briefly introduces the accompanying drawings needed for describing the embodiments or the prior art. Apparently, the accompanying drawings in the following description illustrate some embodiments of the present disclosure, and persons of ordinary skill in the art may still derive other drawings from these accompanying drawings without creative effort.

FIG. 1 is a structural schematic diagram of a sound playing apparatus according to an embodiment of the present application.

FIG. 2 is a structural schematic diagram of a loudspeaker cover plate according to an embodiment of the present application.

FIG. 3 is a structural schematic diagram of a loudspeaker cover plate connecting to a loudspeaker according to an embodiment of the present application.

FIG. 4 is a structural schematic diagram of a substrate according to an embodiment of the present application.

FIG. 5 is a structural schematic diagram of an appearance piece according to an embodiment of the present application.

FIG. 6 is an enlarged view of the area A of FIG. 5.

FIG. 7 is an exploded schematic diagram of a loudspeaker cover plate according to an embodiment of the present application.

FIG. 8 is a structural schematic diagram of a flexible layer according to an embodiment of the present application.

### DESCRIPTION OF REFERENCE SIGNS

100—Sound playing apparatus;
10—Loudspeaker cover plate;
11—Substrate;
111—First through hole;
12—Appearance piece;
121—Second through hole;
13—Flexible layer;
20—Loudspeaker.

### DESCRIPTION OF EMBODIMENTS

To make the objectives, technical solutions, and advantages of embodiments of the present disclosure clearer, the following clearly and comprehensively describes the technical solutions in embodiments of the present disclosure with reference to the accompanying drawings in the embodiments of the present disclosure. Apparently, the described embodiments are a part rather than all embodiments of the present disclosure. All other embodiments obtained by persons of ordinary skill in the art based on the embodiments of the present disclosure without creative effort shall fall within the protection scope of the present disclosure.

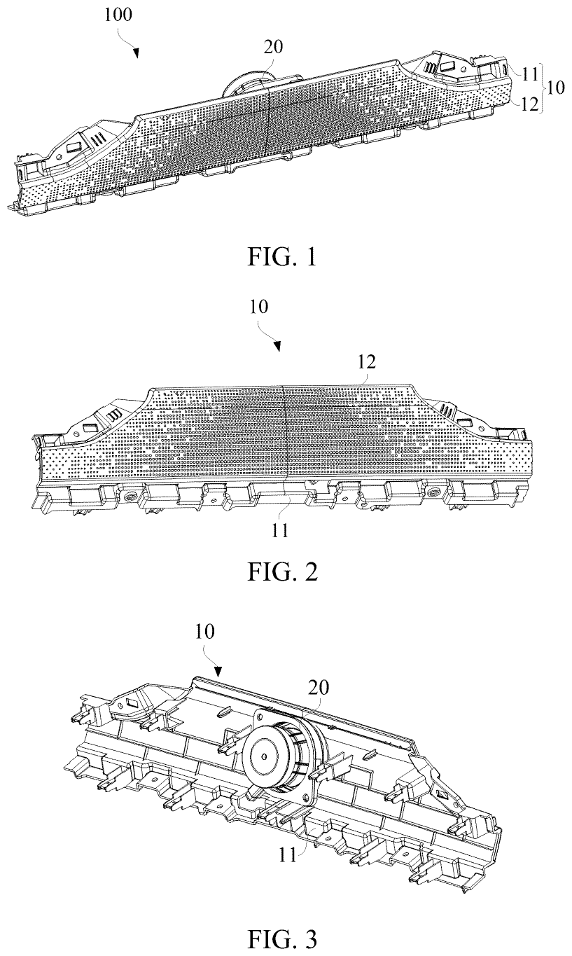

FIG. 1 is a structural schematic diagram of a sound playing apparatus according to an embodiment of the present application.

Embodiments of the present application provide a loudspeaker cover plate, a sound playing apparatus with the loudspeaker cover plate and a terminal with the sound playing apparatus, where the sound playing apparatus may be any apparatus capable of playing sound, such as a radio, player, sound box, speaker, laptop sound box, vehicle sound box, etc. The terminal may be any device with a sound playing apparatus, such as a laptop, vehicle, television, etc.

Taking the terminal as an example of a vehicle, the sound playing apparatus may be an apparatus configured to playing sound in the vehicle, as shown in FIG. 1. The sound playing apparatus 100 may include a loudspeaker 20 and a loudspeaker cover plate 10 covering the loudspeaker 20. The loudspeaker 20 may amplify the sound and make it spread bigger and farther, and the loudspeaker cover plate 10 is configured to shield the loudspeaker 20 to prevent the loudspeaker 20 from being exposed to the air to provide protection for the loudspeaker 20. In addition, the loudspeaker cover plate 10 may also play a decorative role, so as to prevent the loudspeaker 20 from being exposed to the air and affecting the attractiveness of the sound playing apparatus 100, which is beneficial to improve the overall attractiveness of the interior of the vehicle as well as the user experience.

The sound playing apparatus 100 may be provide in the vehicle to facilitate users to listen to music, navigation, etc. For example, the vehicle may include a plurality of the sound playing apparatus 100, which may be evenly distributed in the interior of the vehicle. For example, the sound playing apparatus 100 may be distributed in the dashboard housing, front side door, rear side door and other parts of the vehicle. The dashboard housing may be a structural component for enclosing the dashboard in the vehicle, and the dashboard is an instrument structural component for displaying information and data in the vehicle, where the dashboard housing may facilitate the arrangement of the dashboard and play a protective role for the dashboard.

The sound playing apparatus 100 located on the dashboard housing may facilitate a driver to listen to the sound, while the sound playing apparatus 100 located at the front side door may facilitate a passenger in the front row to listen to the sound, and the sound playing apparatus 100 located at the rear side door may facilitate a passenger in the back row to listen to the sound. In this way, the sound playing apparatus 100 is distributed in multiple positions in the vehicle, so that the sound playing effect is effectively improved and the sound played by the vehicle surround the vehicle is evenly, so that passengers in different positions in the vehicle may clearly hear the sound, which is beneficial to improve the user experience.

The vehicle may also include other structural components for realizing their functions, for example, the vehicle may also include a display apparatus, operation buttons, etc., where the display apparatus may be used to display driving information (such as speed, fuel quantity, fuel consumption, etc.), navigation information, music playing information, etc. The information on the display apparatus may be played by voice function, and spread out through the sound playing apparatus 100, so that the driver and the passenger may listen to it.

Users may operate the display apparatus by operation buttons, for example, turning on navigation, playing music, selecting songs, adjusting the volume, etc., to meet the different requirements of users.

At present, the loudspeaker cover plate is usually a plastic piece. By opening mesh on the loudspeaker cover plate of the plastic piece, sound may spread outward through the mesh of the loudspeaker cover plate, so that the loudspeaker cover plate has sound permeability, which is beneficial to improve the sound playing effect of the sound playing apparatus.

However, the material of the loudspeaker cover plate of the plastic piece is hard and the surface gloss is low, which makes the loudspeaker cover plate have poor touch and texture, reduces the attractiveness of the sound playing apparatus and affects the user experience.

In response to the foregoing problem, the present application provides a loudspeaker cover plate, the touch and the texture of the loudspeaker cover plate are effectively improved, the attractiveness of the sound playing apparatus is improved, and the user experience is improved.

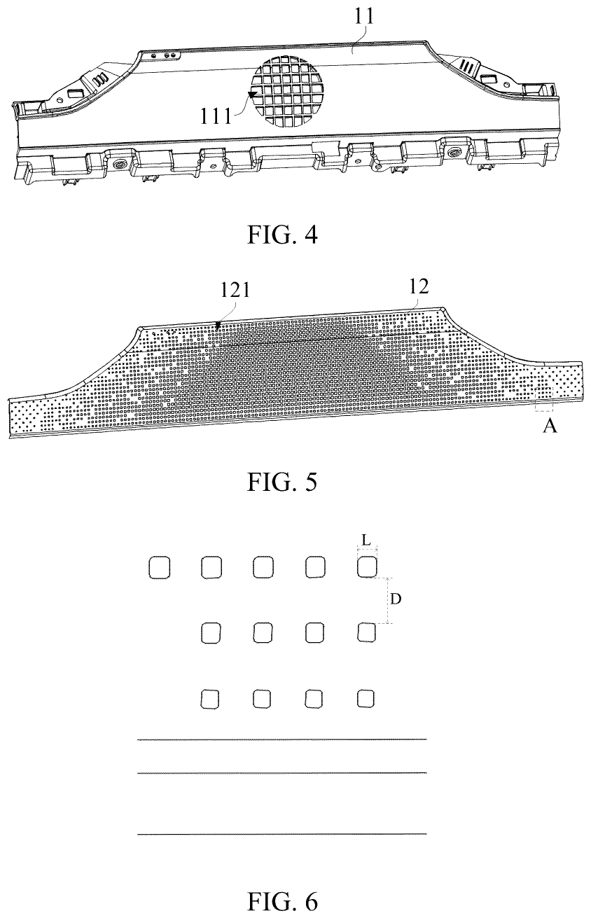

FIG. 2 is a structural schematic diagram of a loudspeaker cover plate according to an embodiment of the present application, FIG. 3 is a structural schematic diagram of a loudspeaker cover plate connecting to a loudspeaker according to an embodiment of the present application, FIG. 4 is a structural schematic diagram of a substrate according to an embodiment of the present application, FIG. 5 is a structural schematic diagram of an appearance piece according to an embodiment of the present application.

As shown in FIG. 2, an embodiment of the present application provide a loudspeaker cover plate 10, including a substrate 11 and an appearance piece 12 covering the substrate 11, where the substrate 11 is the supporting component of the entire loudspeaker cover plate 10, playing a load-bearing role. The substrate 11 may provide rigid support for the loudspeaker cover plate 10, and a structural component which form the loudspeaker cover plate 10 may be centrally arranged on the substrate 11 to form a complete loudspeaker cover plate 10. In addition, the substrate 11 may also facilitate the installation of loudspeaker cover plate 10. For example, as shown in FIG. 3, the substrate 11 may be configured to connect to the loudspeaker 20, allowing the loudspeaker cover plate 10 to be connected to the loudspeaker 20 through the substrate 11.

The substrate 11 and the loudspeaker 20 may be connected in a detachable manner, which facilitates the detachment of the loudspeaker cover plate 10 and facilitates the repairing and maintenance of the sound playing apparatus 100. For example, the detachable connection between the substrate 11 and the loudspeaker 20 may be realized through ways such as clamping, fastening, bonding, and threaded connection.

For example, a first clamping part (not shown in the figures) may be provided on the loudspeaker 20, and a second clamping part (not shown in the figures) matched with the first clamping part may be provided on the substrate 11, and the substrate 11 may be clamped with the loudspeaker 20 through the matching of the first clamping part and the second clamping part.

Alternatively, a threaded hole (not shown in the figures) may be provided on the substrate 11, and a mounting hole (not shown in the figures) may be provided on the loudspeaker 20. The loudspeaker cover plate 10 may also include a threaded fastener matched with the threaded hole, and the threaded fastener may pass through the mounting hole and be matched with the threaded hole, so that the substrate 11 and the loudspeaker 20 may be connected through the threaded fastener.

Alternatively, in some examples, the connection between the substrate 11 and the loudspeaker 20 may also be realized in other ways. Specifically, the connection mode between the substrate 11 and the loudspeaker 20 may be selected and arranged according to specific scene requirements.

The appearance piece 12 may be located on a surface of the substrate 11 away from the loudspeaker 20, that is, the appearance piece 12 is located on the viewing surface of the loudspeaker cover plate 10. The appearance piece 12 may play the role of decorating the loudspeaker cover plate 10 to improve the attractiveness of the loudspeaker cover plate 10, thereby improving the attractiveness of the interior of the vehicle.

An edge part of the appearance piece 12 may be folded inward along an edge of the substrate 11, so that the edge part of the appearance piece 12 may be folded to a surface of the substrate 11 facing the loudspeaker 20, which is beneficial to improve the firmness and reliability of the connection between the appearance piece 12 and the substrate 11 as well as the overall structural stability and reliability of the loudspeaker cover plate 10.

As shown in FIG. 4, a plurality of first through holes 111 are arranged on the substrate 11, so that sound may propagate outward through the first through holes 111, thereby reducing or avoiding the obstruction on sound by the substrate 11 and facilitating the propagation of sound. In addition, a weight of the substrate 11 may be reduced, thereby reducing an overall weight of the loudspeaker cover plate 10, which is beneficial to meet the lightweight design requirements of the loudspeaker cover plate 10.

The first through holes 111 may be centrally arranged and positioned opposite to the loudspeaker 20, so that sound may directly propagate outward through the first through holes 111 after being propagated from the loudspeaker 20. In this way, the obstruction on sound from other parts of the substrate 11 may be effectively reduced or avoided, thereby effectively improving the efficiency of sound propagation from the substrate 11.

A shape of the first through holes 111 on the substrate 11 may be a circle, a square, a triangle or a trapezium.

Alternatively, in some examples, the shape of the first through holes 111 may also be irregular. For example, as shown in FIG. 4, the shape of the first through holes 111 at the edge may be a special shape, so that the first through holes 111 on the substrate 11 are arranged in a certain pattern to form a circular structure as a whole, thereby improving the sound permeability of the substrate 11. Specifically, the shape of the first through holes 111 may be selected and arranged according to specific scene requirements.

As shown in FIG. 5, a plurality of second through holes 121 are arranged on the appearance piece 12, where at least some of the second through holes 121 are opposite to the first through holes 111, so that sound may propagate outward through the first through holes 111 and the second through holes 121, thereby reducing or avoiding the obstruction on sound by the appearance piece 12, which is beneficial to improve the overall sound permeability of the loudspeaker cover plate 10 as well as the sound playing effect of the sound playing apparatus 100.

A forming material of the appearance piece is a leather material, comparing with the plastic loudspeaker cover plate 10, the leather appearance piece 12 is soft, so that the hardness of the loudspeaker cover plate 10 may be effectively reduced, and good touch experience may be brought to a user during touch, thereby effectively improving the touch feeling of the loudspeaker cover plate 10. Moreover, comparing with the plastic loudspeaker cover plate 10, lines on the surface of the leather appearance piece 12 are relatively natural and good in glossiness, so that the texture of the loudspeaker cover plate 10 may be effectively improved, the overall attractiveness of the loudspeaker cover plate 10 is improved, the interior of a vehicle looks more attractive and elegant, which is beneficial to improve the overall attractiveness and the feeling of high class of the interior of the vehicle as well as the user experience.

The forming material of the appearance piece at least includes natural leather (such as cowhide, pigskin, horse skin or sheepskin, etc.), artificial leather, recycled leather or synthetic leather, etc. All the foregoing leather materials have good softness and glossiness, the touch and texture of the appearance piece 12 may be effectively improved, which is beneficial to improve the overall quality and attractiveness of the loudspeaker cover plate 10, thereby improving the attractiveness of the interior of the vehicle as well as the user experience.

In the embodiments of the present application, a shape of the second through holes 121 may be a square, a circle and a triangle, etc. For example, as shown in FIG. 5, the shape of the second through holes 121 may be a square. Specifically, the shape of the second through holes 121 may also be selected and arranged according to specific scene requirements.

It should be understood that the shapes of the first through holes 111 and the second through holes 121 may be the same or different, and embodiments of the present application is not limited.

FIG. 6 is an enlarged view of the area A of FIG. 5.

As shown in FIG. 6, a size of the second through holes 121 may be L, and a value range of L may be 2.5 mm to 5 mm. For example, the size of the second through holes 121 may be 2.5 mm, 3.5 mm or 4.5 mm, etc. In this way, the sound permeability of the appearance piece 12 is effectively improved, reducing or avoiding reduction of the sound permeability of the appearance piece 12 caused by the size of the second through holes 121 being too small, which is beneficial to improve the sound effect of the sound playing apparatus 100. In addition, the effect of the oversized diameter of the second through holes 121 on the attractiveness of the appearance piece 12 may be reduced or avoided, which is beneficial to improve the overall attractiveness of the loudspeaker cover plate 10.

When the shape of the second through holes 121 is the circle, the size L may refer to a diameter dimension of the circle, that is, the diameter of the second through holes 121 may be 2.5 mm to 5 mm. When the shape of the second through holes 121 is the square, the size L may refer to a side length of the square, that is, the side length of the second through holes 121 may be 2.5 mm to 5 mm.

As shown in FIG. 6, a distance between two adjacent second through holes 121 may be D, and a value range of D may be 1.25 mm to 10 mm. For example, the distance between two adjacent second through holes 121 may be 1.25 mm, 2 mm, 5 mm, 8 mm, etc. In this way, reduction of the strength of the appearance piece 12 caused by the distance between two adjacent second through holes 121 being too small may be reduced or avoided, and the appearance piece 12 may be prevented from being broken, which is beneficial to improve the structural stability and reliability of the appearance piece 12. In addition, the obstruction on sound caused by the excessive distance between the two adjacent second through holes 121 may be reduced or avoided, which is beneficial to improve the sound permeability of the appearance piece 12 as well as the sound effect of the sound playing apparatus 100.

It should be noted that for the appearance piece 12, the value of the distance D between any two adjacent first through holes 111 may not be equal. For example, it may enable the distance between the second through holes 121 opposite to the first through holes 111 (i.e. opposite to the loudspeaker 20) to be closer, while the distance between the second through holes 121 far away from the first through holes 111 to be relatively farther. In other words, the second through holes 121 on the part of the appearance piece 12 opposite to the first through holes 111 are relatively dense, so that the sound penetration is improved, thereby improving the sound permeability of the appearance piece 12. On the other hand, the second through holes 121 on the part of the appearance piece 12 far away from the first through holes 111 are relatively scattered, so that the strength of the appearance piece 12 is improved, reducing or avoiding the broken or damage of the appearance piece 12 caused by the dense second through holes 121, which is beneficial to improve the service life of the appearance piece 12.

In the embodiments of the present application, a size of the first through holes 111 may be larger than the size of the second through holes 121. For example, it takes the shapes of the first through holes 111 and the second through holes 121 being squares as an example, a side length of the first through holes 111 may be larger than a side length of the second through holes 121. In this way, the sound shielding of the substrate 11 may be further reduced, the sound permeability of the substrate 11 may be improved, and the sound propagation effect may be improved.

In addition, it is convenient to enable the first through holes 111 to opposite to the second through holes 121, reduce or avoid the misalignment between the first through holes 111 and the second through holes 121 caused by the size of the first through holes 111 being too small, and prevent the sound from being blocked due to the misalignment between the first through holes 111 and the second through holes 121, thus the sound permeability of the loudspeaker cover plate 10 is effectively improved and the sound propagation effect is improved.

Moreover, enabling the size of the first through holes 111 to be larger may be beneficial to reduce the weight of the substrate 11, thereby reducing the overall weight of the loudspeaker cover plate 10, and improving the lightweight design requirements of the loudspeaker cover plate 10.

In the embodiments of the present application, the loudspeaker cover plate 10 further includes a base fabric layer (not shown in the figures), the base fabric layer may be connected to the appearance piece 12, and the base fabric may locate on a surface of the appearance piece 12 facing the substrate 11. For example, the base fabric layer and the appearance piece 12 may be connected by bonding or the like. The base fabric layer has high strength and low elasticity. By connecting the base fabric layer with the appearance piece 12, the strength of the appearance piece 12 may be effectively improved and the appearance piece 12 may be avoided from being broken.

In addition, the elasticity of the appearance piece 12 may be reduced, the elastic deformation of the appearance piece 12 may be reduced or avoided, the deformation of the second through holes 121 caused by the deformation of the appearance piece 12 may be avoided, and the appearance of the loudspeaker cover plate 10 may be prevented from being adversely affected by the deformation of the appearance piece 12 and the second through holes 121, which is beneficial to improve the overall attractiveness of the loudspeaker cover plate 10.

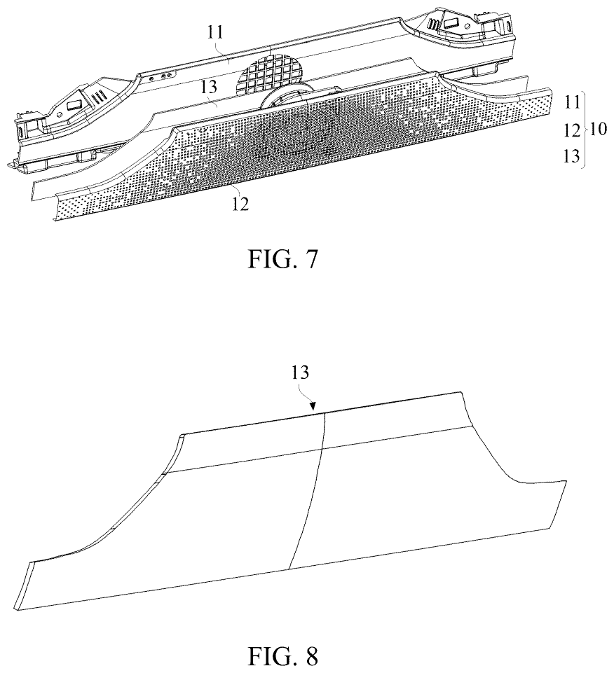

FIG. 7 is an exploded schematic diagram of a loudspeaker cover plate according to an embodiment of the present application, FIG. 8 is a structural schematic diagram of a flexible layer according to an embodiment of the present application.

As shown in FIG. 7, in the embodiments of the present application, the loudspeaker cover plate 10 further includes a flexible layer 13, the flexible layer 13 is located between the appearance piece 12 and the substrate 11. The flexible layer 13 may be a structural component made of a flexible material, which may play a flexible supporting role for the appearance piece 12, so as to realize a good shaping effect on the appearance piece 12, and may reduce or avoid the appearance of the imprint of the first through holes 111 on the appearance piece 12 due to the direct contact of the appearance piece 12 with the substrate 11, which is beneficial to improve the attractiveness of the loudspeaker cover plate 10.

In addition, the flexible layer 13 may effectively improve the flexibility of the surface of the loudspeaker cover plate 10, which is beneficial to further improve the touch of the loudspeaker cover plate as well as the user experience.

The flexible layer may be a 3D mesh fabric (abbreviation is 3D mesh). 3D mesh fabric includes two layers of base fabric and elastic woven materials arranged between the two layers of base fabric. The 3D mesh fabric has good support, which may effectively improve the supporting effect of the appearance piece 12, reduce or avoid the adverse effect of the first through holes 111 on the surface of the appearance piece 12, thereby the aesthetics of the loudspeaker cover plate 10 is effectively improved.

Moreover, the 3D mesh fabric also has good air permeability, which may enable the flexible layer 13 has good sound permeability, and may reduce or avoid the obstruction on sound by the flexible layer 13, thereby the sound permeability of the loudspeaker cover plate 10 is effectively improved, and the sound playing effect of the sound playing apparatus 100 is improved.

In addition, the 3D mesh fabric has good elasticity, which may effectively improve the softness of the surface of the loudspeaker cover plate 10, thereby the touch of the loudspeaker cover plate 10 is improved, and the user experience is improved. In addition, the flexible layer 13 has a certain shielding effect, which may shield the first through holes 111, prevent the loudspeaker 20 and other structures on which from being exposed through the first through holes 111 and the second through holes 121, which is beneficial to improve the attractiveness of the loudspeaker cover plate 10.

A thickness of the flexible layer 13 may be 2 mm to 3 mm, which may effectively improve the shaping effect of the flexible layer 13, and improve the attractiveness of the loudspeaker cover plate 10.

In the description of the present disclosure, it should be understood that the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside” and other directional or positional relationships indicated are based on the directional or positional relationships shown in the accompanying drawings, merely for the convenience of describing the present disclosure and simplifying the description, and do not indicate or imply that the apparatus or element referred to must have a specific orientation, be constructed and operated in a specific orientation, and therefore cannot be understood as a limitation of the present disclosure.

In the description of the present disclosure, it should be understood that the terms “including” and “having” and any variations thereof used herein are intended to cover non exclusive inclusions, such as processes, methods, systems, products or devices that contain a series of steps or units that are not necessarily limited to those steps or units clearly listed, but may include other steps or units that are not clearly listed or inherent to these processes, methods, products or devices.

Unless otherwise specified and limited, the terms “installation”, “connection”, “coupled”, “fixation”, etc. should be broadly understood, for example, they may be fixed connections, detachable connections, or integrated; it may be directly connected or indirectly connected through an intermediate medium, which may establish the internal connection or interaction relationship between two components. For ordinary skilled in the art, the specific meanings of the above terms in the present disclosure may be understood according to the specific situation. In addition, the terms “first”, “second”, etc. are only used for descriptive purposes and cannot be understood as indicating or implying relative importance or implying the number of technical features indicated.

Finally, it should be noted that the foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments or make equivalent substitutions to some or all technical features thereof, without departing from the spirit and scope of the technical solutions of embodiments of the present disclosure.

1. A loudspeaker cover plate, configured to connect to a loudspeaker, wherein the loudspeaker cover plate comprises a substrate and an appearance piece covering the substrate, the substrate is configured to connect to the loudspeaker, and the appearance piece is located on a surface of the substrate away from the loudspeaker;
a plurality of first through holes are arranged on the substrate, a plurality of second through holes are arranged on the appearance piece, and at least some of the second through holes are opposite to the first through holes; and
a forming material of the appearance piece is a leather material.

2. The loudspeaker cover plate according to claim 1, further comprising a flexible layer, wherein the flexible layer is located between the appearance piece and the substrate.

3. The loudspeaker cover plate according to claim 1, further comprising a base fabric layer, wherein the base fabric layer is connected to the appearance piece, and the base fabric is located on a surface of the appearance piece facing the substrate.

4. The loudspeaker cover plate according to claim 1, wherein the forming material of the appearance piece at least comprises natural leather, artificial leather, recycled leather or synthetic leather.

5. The loudspeaker cover plate according to claim 1, wherein a size of the first through holes is larger than a size of the second through holes.

6. The loudspeaker cover plate according to claim 1, wherein a shape of the second through holes at least comprises a square, a circle and a triangle.

7. The loudspeaker cover plate according to claim 1, wherein the size of the second through holes is 2.5 mm to 5 mm, and a distance between the two adjacent second through holes is 1.25 mm to 10 mm.

8. The loudspeaker cover plate according to claim 2, wherein the flexible layer is a three dimensional (3D) mesh fabric.

9. A sound playing apparatus, at least comprising a loudspeaker and a loudspeaker cover plate, wherein the loudspeaker cover plate covers the loudspeaker and is configured to connect to the loudspeaker;
wherein the loudspeaker cover plate comprises a substrate and an appearance piece covering the substrate, the substrate is configured to connect to the loudspeaker, and the appearance piece is located on a surface of the substrate away from the loudspeaker;
a plurality of first through holes are arranged on the substrate, a plurality of second through holes are arranged on the appearance piece, and at least some of the second through holes are opposite to the first through holes; and
a forming material of the appearance piece is a leather material.

10. A terminal, at least comprising a sound playing apparatus, wherein the sound playing apparatus at least comprises a loudspeaker and a loudspeaker cover plate, wherein the loudspeaker cover plate covers the loudspeaker and is configured to connect to the loudspeaker;
wherein the loudspeaker cover plate comprises a substrate and an appearance piece covering the substrate, the substrate is configured to connect to the loudspeaker, and the appearance piece is located on a surface of the substrate away from the loudspeaker:
a plurality of first through holes are arranged on the substrate, a plurality of second through holes are arranged on the appearance piece, and at least some of the second through holes are opposite to the first through holes; and
a forming material of the appearance piece is a leather material.

11. The sound playing apparatus according to claim 9, further comprising a flexible layer, wherein the flexible layer is located between the appearance piece and the substrate.

12. The sound playing apparatus according to claim 9, further comprising a base fabric layer, wherein the base fabric layer is connected to the appearance piece, and the base fabric is located on a surface of the appearance piece facing the substrate.

13. The sound playing apparatus according to claim 9, wherein the forming material of the appearance piece at least comprises natural leather, artificial leather, recycled leather or synthetic leather.

14. The sound playing apparatus according to claim 9, wherein a size of the first through holes is larger than a size of the second through holes.

15. The sound playing apparatus according to claim 9, wherein a shape of the second through holes at least comprises a square, a circle and a triangle.

16. The sound playing apparatus according to claim 9, wherein the size of the second through holes is 2.5 mm to 5 mm, and a distance between the two adjacent second through holes is 1.25 mm to 10 mm.

17. The sound playing apparatus according to claim 11, wherein the flexible layer is a three dimensional (3D) mesh fabric.

18. The terminal according to claim 10, further comprising a flexible layer, wherein the flexible layer is located between the appearance piece and the substrate.

19. The terminal according to claim 10, further comprising a base fabric layer, wherein the base fabric layer is connected to the appearance piece, and the base fabric is located on a surface of the appearance piece facing the substrate.

20. The terminal according to claim 10, wherein the forming material of the appearance piece at least comprises natural leather, artificial leather, recycled leather or synthetic leather.
